(19) United States
(12) Patent Application Publication
(10) Pub. No.: US 2023/0060072 A1
(43) Pub. Date: Feb. 23, 2023

(54) RESPONSIVE PHOTONIC COATING

(71) Applicant: TECHNISCHE UNIVERSITEIT EINDHOVEN, EINDHOVEN (NL)

(72) Inventors: Yari Foelen, Eindhoven (NL); Danielle Anna Catharina Van Der Heijden, Eindhoven (NL); Albertus Petrus Hendrikus Johannes Schenning, Eindhoven (NL); Cornelis Wilhelmus Maria Bastiaansen, Eindhoven (NL)

(21) Appl. No.: 17/915,029

(22) PCT Filed: Mar. 29, 2021
(86) PCT No.: PCT/EP2021/058168

§ 371 Date: Sep. 27, 2022

Related U.S. Application Data
(60) Provisional application No. 63/000,600, filed on Mar. 27, 2020.

(51) Int. Cl. C09D 5/26; G01K 11/165; G01N 31/22

(52) U.S. Cl. CPC C09D 5/26; G01K 11/165; G01N 31/226

(57) ABSTRACT

The present invention relates to a responsive photonic coating and to a substrate provided with such a responsive photonic coating. The present invention also relates to a sensor. An object of the present invention is to provide a responsive photonic coating that can be used for simultaneously measuring the exposure to high temperature and steam, such as in an autoclave.

The present invention relates to a responsive photonic coating and to a substrate provided with such a responsive photonic coating. The present invention also relates to a sensor. The present invention relates to a time integrating optical sensor that irreversibly changes color upon exposure to one or multiple stimuli.

Responsive photonic coatings are known in the art. For example, CN 106977905 discloses a responsive cellulose nanocrystal/polyurethane flexible photonic paper and a coating material. A mixture of cellulose nanocrystal, a waterborne polyurethane emulsion and a cross-linking is dried to form a membrane and the mixture is heated to carry out a cross-linking reaction to obtain the flexible photonic paper or coatings. The obtained material has photochromic features of humidity response and solvent polarity response, and is applied in the field of sensors.

The fabrication of shape memory photonic coatings that irreversibly change both topography and color, i.e. a colorless-to-color transition based on the surface scattering induced in a shape memory polymer, has been described by Nickmans, K.; van der Heijden, D. A. C.; Schenning, A. P. H. J. Photonic Shape Memory Chiral Nematic Polymer Coatings with Changing Surface Topography and Color. Adv. Opt. Mater. 2019, 1900592. https://doi.org/10.1002/adom.201900592. According to that publication polymeric cholesteric liquid crystal films with a red structural color and a smooth surface topography were obtained by high-speed flexographic printing and UV-curing in air of a chiral nematic liquid crystal ink. These coatings were thermally programmed by using a rough stamp resulting in a temporary rough surface topography leading to scattering and a gray color below the glass transition temperature which is at room temperature. By heating the coatings, a total shape recovery to the permanent state was observed, thereby restoring the smooth surface topography and the iridescent red reflection color. That effect is highly temperature dependent, which allows for a fast and distinct optical response upon exceeding the glass transition temperature.

Steam sterilization is a standard method for sterilization of equipment in many dental practices, laboratories and hospitals. Eliminating all micro-organisms by steam sterilization requires exposure to elevated temperature combined with saturated steam under pressure for an extensive amount of time. An autoclave is used to maintain a temperature of 121° C. (250° F.) for at least 20 minutes under saturated steam conditions.

In many countries, it is legally obligated to validate the sterilization process. Typical methods use biological indicators or chemical indicators which are placed inside an autoclave. Biological indicators require time to evaluate and have to be read out under a microscope. Chemical indicators operate by heat triggered coloration (autoclave tapes) or by heat/humidity-controlled diffusion of (toxic) ink. However, low cost optical sensors easily applicable as labels, are desired to verify whether the steam sterilization was performed properly on each item. Hence the development of time-temperature-steam sensors remains a challenge.

Over the last few decades optical sensors based on photonic materials have been developed which are able to respond to a broad range of analytes. These battery-free and easy-to-read sensors have recently gained industrial interest as the production process is scalable and the response can be tailored for different applications. Time temperature sensors may use shape memory photonic materials.

Cholesteric liquid crystals (CLCs) are a class of photonic materials that reflect a certain wavelength of light as a result of the periodic helical ordering that is induced by a chiral dopant in the nematic liquid crystal mesophase. Time temperature sensors based on cholesteric liquid crystals have been demonstrated by compressing the cholesteric structure above the glass transition temperature (Tg).

Another type of optical time temperature sensor is based on imprinting a micro structure on the surface of a shape memory CLC coating via stamping. The “programming” of a rough surface topography in the micrometer range causes light scattering which conceals the reflected color instead of shifting it. A smooth surface is restored when exposed to temperatures above the Tg which reintroduces the initial color.

An object of the present invention is to provide a responsive photonic coating that can be used for simultaneously measuring the exposure to high temperature and steam, such as in an autoclave.

Another object of the present invention is to provide a process for manufacturing a responsive photonic coating that does not require a programming step, i.e. compressing or surface stamping.

Another object of the present invention is to provide a dual stimuli responsive photonic coating.

The present invention thus relates to a responsive photonic coating that loses the cholesteric order as a response to one or more stimuli.

On basis of the above one or more objects are achieved. The present inventors have developed a time-temperature-steam sensitive photonic coating that is based on an irreversible shift from a color reflective state to a light scattering state by making use of the gradual cholesteric structure loss in a non-covalent, supramolecular crosslinked coating that occurs in the isotropic phase.

Without wishing to be literally bound by theory the present inventors assume that the time dependent sensitivity for both temperature and steam originates from the dynamic hydrogen bond sites of the carboxylic acid mesogens in the photonic material. When the coating is exposed to 121 degrees Celsius for 20 minutes, the green color of the photonic coating permanently disappears, offering the possibility to use the time-temperature-steam polymer film as a validation sensor for steam sterilization. The gradual permanent order loss is attributed to the dynamic hydrogen bond interactions which provide supramolecular crosslinking. The hydrogen bonds manifest a dynamic equilibrium between open or cyclic dimers and free carboxylic acid that allows the linear polymer chains to reorient. In the isotropic phase, the absence of order favors the chains to reorient into a disordered, unaligned structure over time which is fixated in the nematic phase after cooling down below Tᵢₛₒ (nematic-isotropic transition temperature).

The additional responsivity for steam or other molecules is twofold: certain molecules can interact with the hydrogen bond sites of the acid mesogens, which allows the cholesteric helices more freedom to reorient, accelerating the cholesteric order loss. Furthermore, the molecules absorbed into the polymer can cause surface roughening resulting in a scattering surface structure. This surface scattering enhances the color loss effect and contributes to the elimination of any residual angular reflection that is observed when the coating is heated without steam.

In an example the photonic coating is a non-covalent, supramolecularly crosslinked coating.

In an example the loss of the cholesteric order is based on supramolecular interactions from carboxylic acid mesogens in a polymeric liquid crystal system.

In an example the one or more stimuli are chosen from the group of temperature, chemical stimulus and pressure.

In an example the one or more stimuli are temperature or steam, or a combination thereof.

In an example the responsive photonic coating shifts from a color reflective state to a light scattering state.

In an example the onset temperature for the isotropic phase transition is at least 105 ° C., preferably at least 121 ° C.

The present invention also relates to a substrate provided with a responsive photonic coating as discussed above.

In addition, the present invention relates to a sensor comprising a substrate as discussed above.

An example of a method for manufacturing a substrate as discussed above comprises the following steps: i) providing a substrate; ii) applying a responsive photonic coating onto the substrate using high speed printing techniques, such as flexography, gravure and inkjet.

The substrate as discussed above can be used as a sensor for irradiation, organic vapors, amines, metal ions, pH-values, and gases, wherein the gases are chosen from the group of ammonia, carbon dioxide, carbon monoxide nitrogen dioxide, nitrogen monoxide and oxygen.

The present invention will now be explained in more detail by means of a number of examples and comparative examples, from which the advantages of the present invention will become apparent.

### FABRICATION OF THE PHOTONIC CLC POLYMER COATING

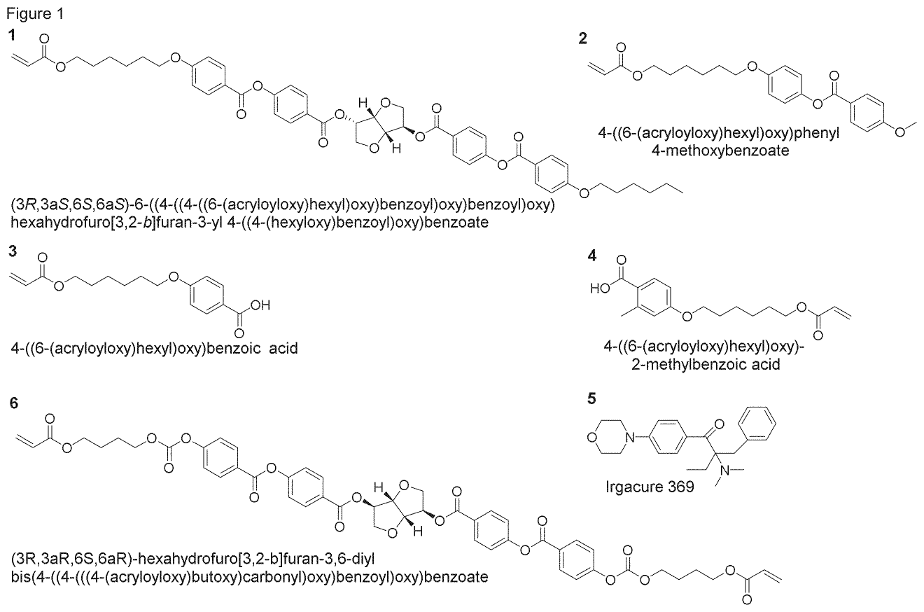

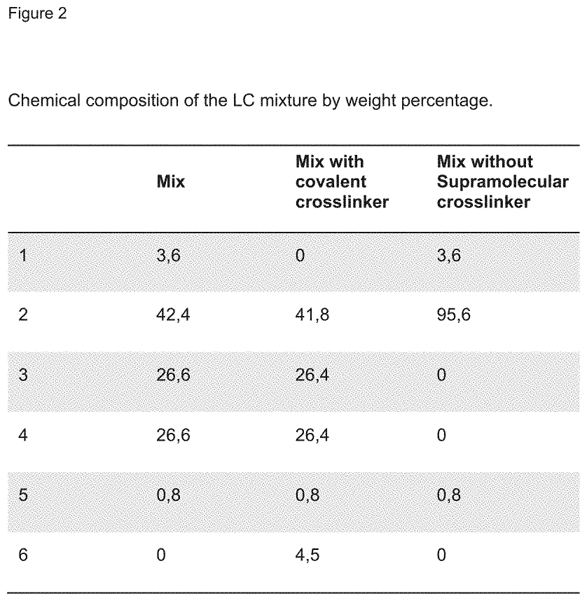

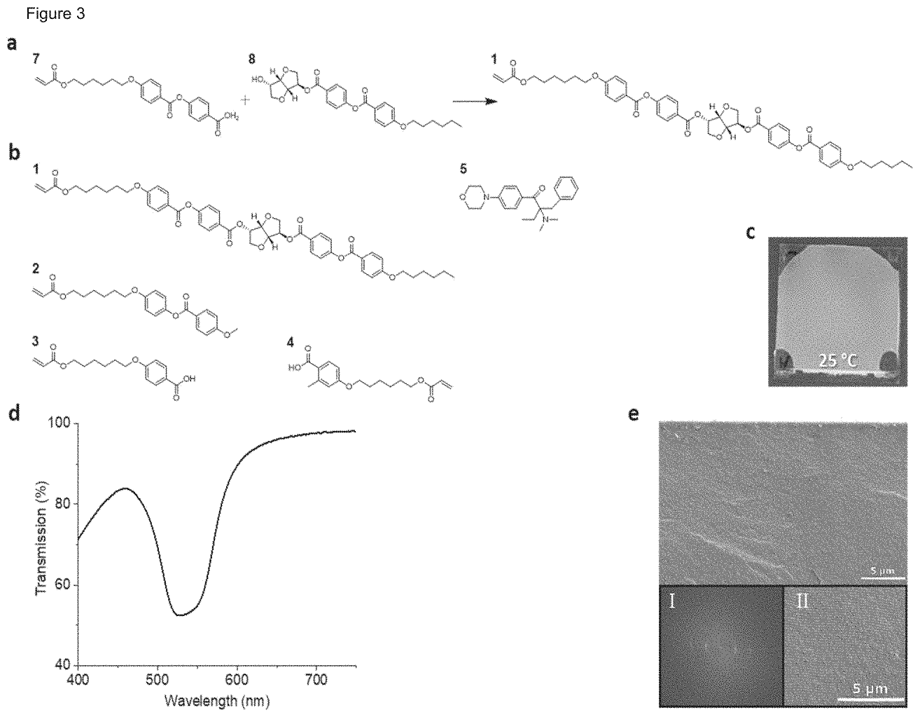

In order to fabricate the photonic CLC(cholesteric liquid crystal) polymer coating containing only hydrogen bonded supramolecular crosslinks. Monoacrylate-based chiral dopant (reference number 1 in FIG. 1) with a high helical twisting power was synthesized (exact composition of the mixtures, see FIG. 2). Chiral dopant (1) resembles a monoacrylate version of the commercially available chiral diacrylate derivative (reference number 6, FIG. 1) with high helical twisting power and was synthesized from two precursors^{31,32} (7) and (8) (FIG. 3) by an esterification reaction. After crystallization the monoacrylate-based chiral dopant 1 was obtained purely and fully characterized. The monoacrylate chiral dopant has a high helical twisting power of 95 μm⁻¹. The CLC mixture contains solely monoacrylate mesogens excluding covalent crosslinking. Liquid crystal monomer (2) is used to tune the crystalline-nematic transition and initiator Irgacure 369 (5) is added for initiating photo polymerization. By incorporating (˜53 wt. %) carboxylic acid-functionalized monoacrylate liquid crystal molecules (3) and (4), supramolecular crosslinking proceeds through the hydrogen bonds between the benzoic acids (FIG. 3).

Photonic coatings are obtained by shearing the CLC mixture between two glass plates to induce cholesteric alignment planar to the substrate or the mixture is applied onto the substrate using high speed printing techniques, such as flexography, gravure and inkjet. The aligned mixture is polymerized at 40° C. with high intensity UV light (˜20 mW/cm²), yielding a green photonic polymer coating with an SRB (selective reflection band) around 530 nm (FIG. 3). In principle every color can be obtained by adjusting the chiral dopant concentration. The periodic cholesteric structure is clearly illustrated by scanning electron microscopy (SEM) images (FIG. 3). The Fourier-transform infrared spectroscopy (FT-IR) spectrum of the polymer coating showed an absence of C=C acrylate stretching vibration peak at 1640 cm⁻¹, the ═CH₂ deformation vibration peak at 1410 cm⁻¹ and the C═C out of plane deformation vibration peak at 985 cm⁻¹, implying that polymerization has occurred. The carbonyl vibration peaks from 1680 to 1730 cm⁻¹ indicate the presence of hydrogen bonded carboxylic acid dimers acting as supramolecular crosslinks. Thermal characterization of the polymer coating by differential scanning calorimetry (DSC) shows a cholesteric to isotropic transition temperature (Tᵢₛₒ) at ˜105° C.

Upon heating the supramolecularly crosslinked photonic coating above Tᵢₛₒ to 120° C., the coating becomes transparent due to the order loss of the photonic structure in the isotropic phase. Upon cooling below Tᵢₛₒ after exposure of the coating to 120° C. for 20 minutes, a white, scattering coating is obtained: the transmission over the entire visible spectrum decreases due to scattering which results in a decrease of the SRB (selective reflection band).

The optical change and the decrease of the SRB through order loss in a polymer coating is related to the coating being exposed to temperatures around or above the threshold Tᵢₛₒ. UV-vis spectra show a tightening of the SRB at 100° C. (<Tᵢₛₒ), caused by the reduction in birefringence near the phase transition temperature. Despite, exposure of the photonic polymer coating to temperatures below Tᵢₛₒ does not change the SRB at room temperature. Exposure above Tᵢₛₒ is time and temperature dependent: an exposure of 15 minutes above Tᵢₛₒ at a temperature of 110° C. has no significant effect on the SRB of the coating at room temperature. However, 60 minutes of exposure to 110° C. results in a decrease of the SRB. The SRB decrease after 60 minutes at 110° C. is comparable to the decrease of 20 minutes exposure to 120° C. In other words, when the coating becomes transparent above Tᵢₛₒ, the exposure is actively recorded by the cholesteric order loss (vide infra) as a function of time and temperature which is optically expressed as a decrease in SRB at room temperature.

The gradual permanent order loss is attributed to the dynamic hydrogen bond interactions which provide supramolecular crosslinking. The hydrogen bonds manifest a dynamic equilibrium between open or cyclic dimers and free carboxylic acid that allows the linear polymer chains to reorient. When a supramolecular crosslink becomes a free acid, the absence of a network allows for reformation of a cyclic/open dimer in a different position. In the isotropic phase, the absence of order favors the chains to reorient into a disordered, unaligned structure over time which is fixated in the nematic phase after cooling down below Tᵢₛₒ.

Further proof that the time temperature dependent functionality is induced by a dynamic hydrogen bond based mechanism, becomes evident when two additional polymer coatings are compared (compositions in FIGS. 1 and 2). A photonic coating without hydrogen bond forming mesogens, i.e. containing only 1 and 2, demonstrates the absence of a time factor: the coating immediately loses the cholesteric structure after exposure to a temperature above T10. Without supramolecular hydrogen bond crosslinking, no network-like forces are keeping the orientation preserved, as such the cholesteric structure of the nematic phase is instantenously lost when heated to the isotropic state. Contrarily, a coating with the covalent crosslinked chiral dopant (6, see FIG. 1 and FIG. 2) shows that there is no structure loss possible through exposure to a temperature above Tᵢₛₒ. Due to the diacrylate chiral dopant, a network is formed with chemical crosslinks. This will preserve the cholesteric structure in the nematic phase, even after an extensive time in the isotropic phase.

The present inventors studied the application of the time-temperature sensitive photonic coating as an optical steam sterilization sensor. The effect of steam on the color change was studied. When the coating is placed inside an autoclave to apply typical conditions of a standardized method for sterilization, 20 minutes of exposure to saturated steam at 121° C. ensures a complete loss of the SRB (selective reflection band) instead of the decrease of the SRB after exposure to 120° C. for 20 minutes. Water molecules can interact with the hydrogen bond sites of the acid mesogens, which allows the cholesteric helices more freedom to reorient, accelerating the cholesteric order loss. Furthermore, the water absorbed into the polymer causes surface roughening after drying, resulting in a scattering surface structure. This surface scattering enhances the color loss effect and contributes to the elimination of any residual angular reflection that is observed when the coating is heated without steam. A modified autoclave program at a lower temperature (110° C. for 20 minutes) was tested to simulate an insufficient sterilization process, which did not result in a complete color loss of the CLC (cholesteric liquid crystal) coating.

The present invention thus relates to a time-temperature-steam photonic sensor based on a supramolecularly crosslinked CLC polymer coating. Due to absence of covalent crosslinking, the exposure to a temperature above Tᵢₛₒ can be tracked as a decrease in the SRB (selective reflection band). The time-temperature dependence of coatings above Tᵢₛₒ is recorded as a gradual structure loss of the cholesteric reflective system which is fixated below Tᵢₛₒ. The structure loss is controlled by the dynamic hydrogen bond equilibrium allowing for the time-temperature dependent order loss, resulting in the loss in reflection band. Additionally, the presence of saturated steam influences this equilibrium and accelerates the order loss, as such time-temperature-steam exposure can be recorded which makes this particularly interesting for high temperature-humidity applications such as steam sterilization validation sensors. It is also possible to alter Tᵢₛₒ in order to achieve total SRB loss exactly in the timeframe necessary for the temperature and humidity conditions to guarantee sterilization. These coatings can be inkjet printed as labels and form an alternative to current commercial sensors that are mainly based on the diffusion or solubility of inks.

According to the present invention cholesteric liquid crystal coatings were prepared by dissolving all components in tetrahydrofuran (THF) to ensure a homogenous monomer mixture. For structural names and the exact composition of the mixture, see FIG. 1 and FIG. 2. The concentration of chiral dopant was chosen such that a coating with SRB in the visible spectrum was obtained. A monofunctional chiral dopant 1 obtained from synthesis was used to exclude any covalent crosslinking. Liquid crystal monomer 2 helps to control the crystalline-nematic transition. By incorporating (˜53 wt. %) carboxylic acid-functionalized monoacrylate liquid crystal molecules 3 and 4, supramolecular crosslinking proceeds through the hydrogen bonds between polymer strands. Initiator 5 (Irgacure 369) is used for initiating UV polymerization.

Methacrylate functionalized and perfluoro coated glass slides were prepared as reported by Stumpel et al. Glass substrates were cleaned by sonication (ethanol, 15 minutes) followed by treatment in a UV-ozone photoreactor (Ultra Violet Products, PR-100, 20 minutes) to activate the glass surface. The surface of the glass substrates was modified by spin coating 3-(trimethoxysilyl)propyl methacrylate solution (1 vol.% solution in a 1:1 water-isopropanol mixture) or 1H, 1H, 2H, 2H-perfluorodecyltriethoxysilane solution (1 vol.% solution in ethanol) onto the activated glass substrate for 45 s at 3000 rpm, followed by curing for 10 minutes at 100° C.

After evaporation of the solvent (THF) from the mixture, coatings were obtained by shearing the LC between two glass plates to induce cholesteric alignment planar to the substrate. The two glass plates create a cell that can easily be opened after polymerization: one methacrylate functionalized glass plate covalently bonds with the coating, the other fluorinated-alkylsilane functionalized glass plate ensures detachment from the coating. The cell gap was chosen to be 18 μm by using a glue with 18 μm glass spacer beads. Photopolymerization was performed in the cholesteric phase at 40° C. for 5 minutes at approximately 20 mW/cm². After the cells were opened, the polymeric coatings remained on the acrylate functionalized glass substrate.

Thermal transitions of the liquid crystalline coatings were analyzed by differential scanning calorimetry using a TA Instruments Q1000 calorimeter with constant heating and cooling rates of 10° C/minutes The reflection of the CLC (cholesteric liquid crystal) coatings was measured through ultraviolet-visible spectroscopy by using a PerkinElmer LAMBDA 750 with a 150 mm integrating sphere over a range of 400-750 nm and equipped with a Linkam THMS600 heating stage to measure transmission spectra at specific temperatures. The temperature dependent equilibrium of the hydrogen bonding was monitored by infrared spectroscopy using a Varian FT-IR3100 equipped with a heatable Golden Gate ATR accessory in the range of 1800-1600 cm⁻¹ to focus on the cyclic/open dimer-monomer ratio of the liquid crystalline benzoic acids. Full polymerization was confirmed by comparing the spectrum of the polymer and monomer mixture in the range 1350-1800 cm⁻¹. The cholesteric structure was analyzed by scanning electron microscopy using a Quanta 3D FEG, the coating was cryogenically broken in liquid nitrogen to obtain a cross section and sputter-coated with gold at 60 mA over 30 s. The settings for SEM analysis in secondary electron mode were acceleration of 5 kV, working distance (WD) of 10 mm and under high vacuum. Surface profile characterization was performed using a Bruker DektakXT, set to measurement range 65.5 μm and stylus force 3 mg.

Steam sterilization is generally performed in an autoclave. The combination of steam and heat destroys microorganisms by the irreversible coagulation and denaturation of enzymes and structural proteins. Specific temperatures must be obtained to ensure the microbicidal efficiency, which is achieved with saturated steam under pressure at elevated temperature. The steam-sterilizing method used a temperature of 121° C. for a period of 20 minutes at 2.1 bar, which are the recommended minimum exposure conditions for sterilization of wrapped healthcare supplies. To simulate a failed steam sterilization process, the temperature was changed to 110° C. (same period of 20 minutes at 2.1 bar).

1-12. (canceled)

13. A responsive photonic coating configured to lose its cholesteric order as a response to one or more stimuli.

14. The responsive photonic coating according to claim 13, wherein the photonic coating is a non-covalent, supramolecularly crosslinked coating.

15. The responsive photonic coating according to claim 13, wherein the loss of the cholesteric order is based on supramolecular interactions from carboxylic acid mesogens in a polymeric liquid crystal system.

16. The responsive photonic coating according to claim 13, wherein the one or more stimuli are selected from the group including temperature, chemical stimulus, and pressure.

17. The responsive photonic coating according to claim 16, wherein the one or more stimuli include at least one of temperature and steam.

18. The responsive photonic coating according to claim 13, wherein the responsive photonic coating is configured to shift from a color reflective state to a light scattering state.

19. The responsive photonic coating according to claim 13, wherein an onset temperature for an isotropic phase transition of the responsive photonic coating is at least 105° C.

20. The responsive photonic coating according to claim 13, wherein an onset temperature for an isotropic phase transition of the responsive photonic coating is at least 121° C.

21. A sensor, comprising:
a substrate; and
a responsive photonic coating applied to the substrate, the responsive photonic coating configured to lose its cholesteric order responsive to exposure to one or more stimuli.

22. The sensor according to claim 21, wherein the sensor is operative to sense at least one of irradiation, organic vapors, amines, metal ions, pH-values, and gases.

23. The sensor according to claim 22, wherein the gases include at least one of ammonia, carbon dioxide, carbon monoxide, nitrogen dioxide, nitrogen monoxide, and oxygen.

24. A method for manufacturing a substrate, comprising the steps of:
providing a substrate; and
applying a responsive photonic coating onto the substrate via a high-speed printing technique, wherein the responsive photonic coating is configured to lose its cholesteric order responsive to exposure to one or more stimuli.

25. The method according to claim 23, wherein the high-speed printing technique includes at least one of flexography, gravure printing, and inkjet printing.
